(19) United States
(12) Patent Application Publication
(10) Pub. No.: US 2007/0081791 A1
(43) Pub. Date: Apr. 12, 2007

(54) Reproducing method and apparatus to simultaneously reproduce a plurality of pieces of data

(75) Inventors: Hye-jeong Chun, Yongin-si (KR); Kil-soo Jung, Hwaseong-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/545,690

(22) Filed: Oct. 11, 2006

(30) Foreign Application Priority Data
Oct. 11, 2005 (KR) 2005-95505
Oct. 12, 2005 (KR) 2005-96202
Sep. 28, 2006 (KR) 2006-95056

(51) Int. Cl. H04N 7/00

(52) U.S. Cl. 386/95

(57) ABSTRACT

A method and an apparatus to reproduce at least one piece of data. The apparatus includes a data reproducing unit to reproduce the at least one piece of video data, an additional data reproducing unit to reproduce one of a plurality of pieces of additional data, each being related to one of the at least one piece of video data, and a control unit to control the additional data reproducing unit to select and reproduce one of the pieces of additional data. Accordingly, setting a plurality of pieces of additional data to be simultaneously reproduced according to a preference of a user when reproducing a plurality of pieces of video data is possible, and switching from a piece of additional data to another piece of the additional data, which are linked to a particular piece of video data, is also possible.

### CROSS-REFERENCE TO RELATED PATENT APPLICATION

This application claims the benefit of Korean Applications Nos. 2005-95505, filed Oct. 11, 2005, 2005-96202, filed Oct. 12, 2005, and 2006-95056, filed Sep. 28, 2006 in the Korean Intellectual Property Office, the disclosures of which are incorporated herein by reference.

### BACKGROUND OF THE INVENTION

1. Field of the Invention

Aspects of the present invention relate to a method and apparatus to simultaneously reproduce a plurality of pieces of data.

2. Description of the Related Art

When simultaneously reproducing a plurality of video streams that each define a graphic stream to be reproduced together with a corresponding video stream using a reproducing apparatus, defining which graphic stream is selected and output, and defining how to handle a graphic decoder and a graphic plane when a video stream remains stationary is required. The reproducing apparatus includes a plurality of video decoders to simultaneously reproduce at least one video stream, a plurality of video planes to display decoded output video, and a decoder and a graphic plane to reproduce other graphic streams (a menu stream and/or a subtitles stream) which are synchronized with the video streams.

Various types of reproducing apparatus that reproduce moving images and subtitles using data for main videos and data for sub videos, which are each stored in a recording medium, are as follows. One type of reproducing apparatus simultaneously reproduces main videos and sub videos and includes a video decoder and a video plane for each item of main video data and sub video data. Another type of reproducing apparatus outputs only a single piece of subtitle data at a time, since a subtitle data decoder and a subtitle data output plane are shared by subtitle data for main video data and subtitle data for sub video data.

FIG. 1 is a schematic block diagram of a conventional reproducing apparatus 100 capable of reproducing a plurality of pieces of video data. As shown in FIG. 1, the apparatus 100 includes a buffer 110, a main video decoder 120, a sub video decoder 130, a subtitle decoder 140, a main video plane 150, a sub video plane 160, and a subtitle plane 170.

The recording medium 105 stores main video data, a plurality of pieces of subtitle data that are graphic data related to the main video data, a plurality of pieces of sub video data that can be reproduced together with the main video data, and a plurality of pieces of subtitle data that are graphic data related to the sub video data.

The buffer 110 buffers data read from the recording medium 105.

The main video decoder 120 decodes the main video data, the sub video decoder 130 decodes the sub video data, and the subtitle decoder 140 decodes the subtitle data.

The main video plane 150 contains the main video data decoded by the main video decoder 120 so as to be able to output the decoded main video data. The sub video plane 160 contains the sub video data decoded by the sub video decoder 130 so as to be able to output the decoded sub video data. The subtitle plane 170 contains the subtitle data decoded by the subtitle decoder 170 so as to be able to output the decoded subtitle data.

With reference to FIG. 1, since a decoder and a video plane are present for each main video and sub video, substantially reproducing the main video and sub video are possible. Also, since subtitle data related to the main video and subtitle data related to the sub video share a subtitle decoder and an output plane, the reproducing apparatus 100 is capable of decoding subtitle data for main video or subtitle data for sub video and is capable of sequentially outputting the results of the decoding.

As is illustrated in FIGS. 2A and 2B, if a write operation is performed on a recording medium that stores main video data 210 and sub video data 230, by using a conventional decoder model, subtitle data 220 for the main video data 210 may be output when only the main video data 210 is reproduced. Furthermore, when sub video data 230 is reproduced together with the main video data 210 after a specific amount of time, subtitle data 240 for the sub video data 230 may be automatically output as is illustrated in FIG. 2A. Otherwise, subtitle data 220 for the main video data 210 may be output regardless of a state of reproduction of the sub video data 230, as is illustrated in FIG. 2B.

As is illustrated in FIGS. 2A and 2B, when the sub video data 230 containing related subtitle data is reproduced while the subtitle data 220 for the main video data 210 is output, data reproduction is performed, as illustrated in FIGS. 2A or 2B, depending on the type of reproducing apparatus being used. This situation may be confusing for a user. Also, when subtitles are changed while the subtitles are displayed, without consent of the user, the user may feel inconvenienced. Accordingly, there is a need for development of a method of allowing a user to select whether to change or maintain the output of subtitle data.

Also, when both subtitles related to main video data and subtitles related to sub video data are present, allowing a user to select whether to switch from subtitles for main video data to subtitles for sub video data, or vice versa, is desirable.

### SUMMARY OF THE INVENTION

Aspects of the present invention provide a reproducing apparatus and a method that are capable of setting additional data to be reproduced simultaneously with a plurality of pieces of video data according to a preference of a user, and allowing a switch to be performed between a plurality of pieces of additional data that are linked to a particular piece of video data.

According to an aspect of the present invention, there is provided an apparatus to reproduce at least one piece of video data, the apparatus comprising a data reproducing unit to reproduce the at least one piece of video data; an additional data reproducing unit to reproduce one of a plurality of pieces of additional data, each being related to one of the at least one piece of video data; and a control unit to control the additional data reproducing unit to select and reproduce one of the pieces of additional data.

The data reproducing unit may comprise a plurality of video decoders to decode the at least one piece of video data; and a plurality of video planes to output the decoded video data, wherein the additional data reproducing unit comprises an additional data decoder to decode the additional data selected by the control unit; and an additional data plane to output the decoded additional data.

The control unit may comprise a switch to perform a switch between the pieces of the additional data so as to input one of the pieces of additional data to the additional data reproducing unit; and a switch controller to control the switch to select one of the pieces of additional data according to a received command.

The received command may be one of a user operation or a navigation command.

The control unit may further comprise a system register storing user preference information regarding one of the pieces of additional data, which is to be reproduced.

The user preference information stored in the system register may be set according to a user operation or a navigation command.

The switch controller may reset the additional data decoder and the additional data plane according to the user operation or the navigation command.

The additional data may comprise at least one of subtitle data, on screen display data, menu data, and graphic data.

The pieces of additional data may comprise subtitle data for main video; and subtitle data for sub video. The received command may comprise one of a command which instructs that switching be performed from the subtitle data for the main video to the subtitle data for the sub video; and a command which instructs that switching be performed from the subtitle data for sub video to the subtitle data for main video.

The system register may comprise a register storing a subtitle stream number for the main video; and a register storing a subtitle stream number for the sub video.

The pieces of the additional data may comprise subtitle data for main video; and subtitle data for sub video. The received command may comprise a command that instructs currently set user preference information to be toggled.

The system register may comprise a valid flag identifying whether the user preference information represents the subtitle data for the main video or the subtitle data for the sub video.

According to another aspect of the present invention, there is provided a method of reproducing a plurality of pieces of video data, the method comprising decoding the pieces of video data; selecting one of a plurality of pieces of additional data, each being related to one of the pieces of video data; decoding the selected piece of additional data; and outputting the decoded pieces of video data together with the decoded piece of additional data.

According to another aspect of the present invention, there is provided a method of controlling reproduction of a plurality of pieces of video data, the method comprising determining whether sub additional data for sub video data is present when a plurality of pieces of video data including main video data and the sub video data is reproduced; when it is determined that the sub additional data is not present, maintaining states of an additional data decoder and an additional data plane which are being currently used; when it is determined that the sub additional data is present, referring to a system register which stores user preference information indicating whether to select main additional data or sub additional data; and controlling the additional data decoder and the additional data plane according to the user preference information.

The controlling of the additional data decoder and the additional data plane may comprise maintaining the states of the current additional data decoder and additional data plane, when the user preference information represents the main additional data; and resetting the current additional data decoder and additional data plane and controlling the sub additional data to be input to the additional data decoder, when the user preference information represents the sub additional data.

According to another aspect of the present invention, there is provided a method of controlling reproduction of a plurality of pieces of video data, the method comprising when a user input is received, which instructs a switch from additional data for main video to additional data for sub video, resetting an additional data decoder and an additional data plane which are currently being used, and switching so as to input the additional data for the sub video to the additional data decoder; and when a user input is received, that instructs a switch from the additional data for the sub video to the additional data for the main video, resetting the current additional data decoder and additional data plane, and switching so as to input the additional data for the main video to the additional data decoder.

According to another aspect of the present invention, there is provided a method of controlling reproduction of a plurality of pieces of video data, the method comprising determining whether additional data that is currently being reproduced is main additional data for main video data or sub additional data for sub video data, when reproduction of sub video data is completed during reproduction of a piece of additional data, which is related to one of the pieces of the video data and is linked to a particular piece of the video data, while reproducing the pieces of the video data including the main video data and the sub video data; when it is determined that the additional data that is being currently reproduced is main additional data, maintaining states of an additional data decoder and an additional data plane that are currently used; and when it is determined that the additional data that is being currently reproduced is sub additional data, resetting the current additional data decoder and additional data plane, and switching so as to input the main additional data to the additional data decoder.

The method may further comprise referring to a system register which stores a stream number of the main additional data that is to be reproduced, and decoding and reproducing a piece of the additional data corresponding to the stored stream number.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic block diagram of a conventional reproducing apparatus capable of reproducing a plurality of pieces of video data;

FIGS. 2A and 2B are reference diagrams illustrating a conventional method of controlling reproduction of subtitle data for individual pieces of video data;

FIG. 3 is a schematic block diagram of a reproducing apparatus capable of reproducing a plurality of pieces of video data according to an embodiment of the present invention;

FIG. 4 is a flowchart illustrating a method of reproducing a plurality of pieces of video data according to an embodiment of the present invention;

FIG. 5 is a detailed block diagram of the reproducing apparatus illustrated in FIG. 3 according to an embodiment of the present invention;

FIG. 6A is a block diagram illustrating a user operation that is input to a switch controller of FIG. 5;

FIG. 6B is a detailed block diagram of a system register according to an embodiment of the present invention;

FIG. 7A is a block diagram illustrating a user operation that is input to the switch controller illustrated in FIG. 5 according to another embodiment of the present invention;

FIG. 7B is a block diagram of the system register illustrated in FIG. 7A according to another embodiment of the present invention;

FIG. 8 is a block diagram illustrating a command input to the switch controller illustrated in FIG. 5 according to an embodiment of the present invention;

FIG. 9 is a flowchart illustrating a method of processing subtitle data when main video and sub video are simultaneously reproduced by using a reproducing apparatus according to an embodiment of the present invention;

FIG. 10 is a flowchart illustrating an operation of a reproducing apparatus when reproduction of sub video is completed according to an embodiment of the present invention;

FIG. 11 is a flowchart illustrating a method of switching between reproduction of one piece of subtitle data and reproduction of another piece of subtitle data, where each piece of subtitle data is from among a plurality of pieces of subtitle data each being related to one piece of video data, which are linked to a particular piece of video data, while reproducing the pieces of the video data according to the user operation illustrated in FIG. 6A, according to an embodiment of the present invention;

FIG. 12 is a flowchart illustrating a method of switching between reproduction of one piece of subtitle data and reproduction of another piece of subtitle data, where each piece of subtitle data is from among a plurality of pieces of subtitle data each being related to one piece of video data, which are linked to a particular piece of video data, while reproducing the pieces of the video data according to the user operation illustrated in FIG. 6A, according to another embodiment of the present invention; and

FIG. 13 is a flowchart illustrating switching between reproduction of a piece of subtitle data and reproduction of another piece of subtitle data, where each piece of subtitle data is from among a plurality of pieces of subtitle data each being related to one piece of video data, which are linked to a particular piece of the video data, while reproducing the pieces of the video data according to the command illustrated in FIG. 7A, according to an embodiment of the present invention.

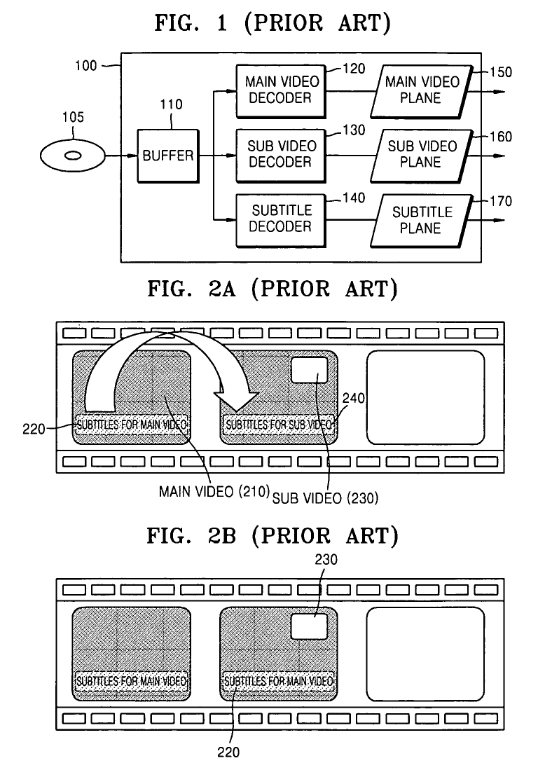

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

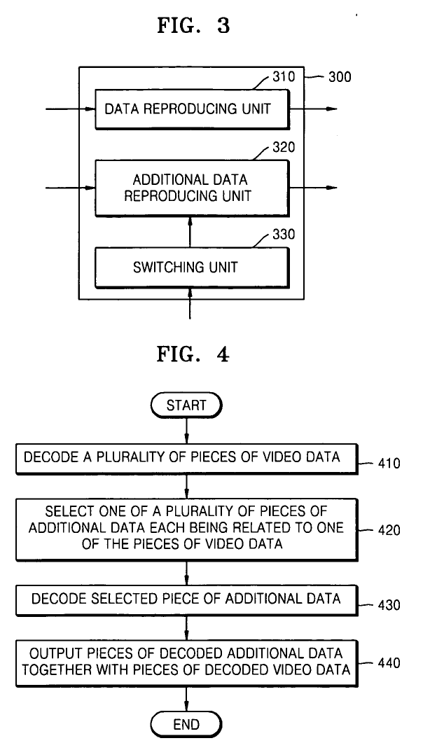

FIG. 3 is a schematic block diagram of a reproducing apparatus 300 that is capable of reproducing a plurality of pieces of video data. As shown in FIG. 3, the reproducing apparatus 300 includes a data reproducing unit 310, an additional data reproducing unit 320, and a switching unit 330. The data reproducing unit 310 receives a plurality of pieces of video data and reproduces them via a decoder. The data reproducing unit 310 is capable of reproducing a plurality of pieces of video data at the same time.

The additional data reproducing unit 320 receives one of a plurality of pieces of additional data that is related to the individual pieces of video data, and reproduces the received piece of additional data via a decoder or the like. The additional data may be any type of data, such as subtitle data, menu data, graphic data, and OSD data, which may be added to video data that is to be reproduced by the data reproducing unit 310.

The switching unit 330 selects one of the pieces of the additional data related to the corresponding pieces of video data, and controls the additional data reproducing unit 320 to reproduce the selected piece of the additional data. In an embodiment of the present invention, preventing the reproducing apparatus 300 from experiencing difficulty in selecting a piece of additional data related to one of a plurality of pieces of data is possible when reproducing the pieces of data by using the switching unit 330 that selects and controls the additional data reproducing unit 320 to reproduce one of the pieces of the additional data.

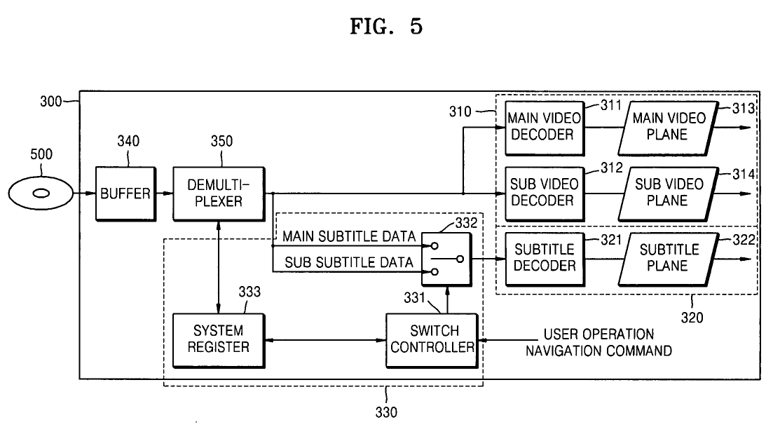

FIG. 4 is a flowchart illustrating a method of reproducing a plurality of pieces of video data according to an embodiment of the present invention. As shown in FIG. 4, the data reproducing unit 310 decodes a plurality of pieces of video data (Operation 410). The switching unit 330 selects one of a plurality of pieces of additional data related to a plurality of corresponding pieces of video data (Operation 420). Next, the additional data reproducing unit 320 decodes the piece of additional data selected by the switching unit 330 (Operation 430). Then, the reproducing apparatus outputs pieces of decoded additional data together with pieces of decoded video data (Operation 440).

FIG. 5 is a detailed block diagram of the reproducing apparatus 300 illustrated in FIG. 3, in which subtitle data is used as an example of additional data. As shown in FIG. 5, the reproducing apparatus 300 includes a buffer 340, a demultiplexer 350, a main video decoder 311, a sub video decoder 312, a main video plane 313, a sub video plane 314, a subtitle decoder 321, a subtitle plane 322, a switch controller 331, a switch 332, and a system register 333. The main video decoder 311, the sub video decoder 312, the main video plane 313, and the sub video plane 314 form a data decoding reproduction unit 310. The subtitle decoder 321 and the subtitle plane 322 form an additional data reproducing unit 320. The switch controller 331, the switch 332, and the system register 333 form a switching unit 330.

A recording medium 500 stores video data which is main object data, a plurality of pieces of subtitle data to act as additional data that are related to the main video data, a plurality of pieces of sub video data that may be reproduced together with the main video data, and a plurality of pieces of subtitle data to act as additional data related to the sub video data. For example, the main video data may be a title of a movie displayed on a display device in full screen mode, and the sub video data may provide information that is related to the movie that is being displayed. As a further example, the sub video data may be an explanation regarding an aspect of the movie that is provided by the director of the movie. The sub video data may be displayed in a window provided in a part of a screen on which the movie is displayed. Also, the subtitle data related to the main video data may be subtitles of the movie, and the subtitle data related to the sub video data may be subtitles that are comments made by the director of the movie.

The buffer 340 buffers data read from the recording medium 500.

The demultiplexer 350 divides the data received via the buffer 340 into main video data, sub video data, and subtitle data according to the stream properties, and transmits the main video data to the main video decoder 311, the sub video data to the sub video decoder 312, and the subtitle data to the subtitle decoder 321. Also, although not illustrated in the drawings, when audio data is present, main audio data and sub audio data may be respectively transmitted to a main audio decoder and a sub audio decoder. In particular, in an embodiment of the present invention, when pieces of data having the same properties are present, the demultiplexer 350 transmits data to a corresponding decoder. The transmitted data corresponds to a stream number stored in the system register 333 that stores the stream number of stream to be reproduced. That is, the demultiplexer 350 transmits, to the subtitle decoder 321, subtitle data corresponding to the stream number of a subtitle stream to be reproduced, which is stored in the system register 333.

The main video decoder 311 decodes the main video data, the sub video decoder 312 decodes the sub video data, and the subtitle decoder 321 decodes the subtitle data. Although FIG. 5 illustrates an embodiment of the present invention with respect to a situation in which only the subtitle data is added, the present invention is not limited thereto. That is, the present invention is applicable to any type of data (subtitle data, menu data, graphic data, OSD data, etc.) that may be added to main video or sub video.

The main video plane 313 contains the decoded main video data so as to be able to output decoded main video data, the sub video plane 314 contains the decoded sub video data so as to be able to output decoded sub video data, and the subtitle plane 322 contains the decoded subtitle data so as to be able to output decoded subtitle data.

The switch 332, the subtitle decoder 321, the switch controller 331, and the system register 333 will now be described in greater detail. Since the subtitle decoder 321 and the subtitle plane 322 are shared by the main subtitle data and the sub subtitle data, the subtitle decoder 321 and the subtitle plane 322 must select whether to process the main subtitle data or the sub subtitle data.

The switch 332 performs switching between data for a plurality of subtitles that can be input to the subtitle decoder 321. The switch controller 331 controls the switch 332 according to a user operation or a navigation command, and stores user preference information according to user operations or navigation commands in the system register 333.

The system register 333 is a register that stores user preference information regarding which subtitle data will be used, when main video data and sub video data are simultaneously reproduced and each piece of video defines data for all subtitles. For example, the user preference information may comprise information that is selected by a user, which indicates whether to reproduce main subtitle data for main video data or sub subtitle data for sub video data, when simultaneously reproducing main video data and sub video data. As shown in FIG. 5, a register that stores user preference information may comprise a system register 333, but the present invention is not limited thereto. The system register 333 may be any storage unit capable of storing user preference information.

When only main video data is reproduced and reproduction of sub video data begins, the switch controller 331 is able to control the switch 332 depending on whether to select the main subtitle data or the sub subtitle data, based on the user preference information stored in the system register 333. Also, even while main video data and sub video data are simultaneously reproduced and only one of either main subtitle data or sub subtitle data is reproduced, a user may desire to switch from the main subtitle data to the sub subtitle data or vice versa. In this case, the switch controller 331 also receives a user operation or a navigation command according to the preference of the user, stores the content in the received command as user preference information in the system register 333, and controls the switch 332 according to the user preference information.

Also, when reproduction of sub video data is completed while main video data and sub video data is simultaneously reproduced and a piece of sub subtitle data is reproduced, sub subtitle data related to the sub video data need not be reproduced any longer. Thus, the switch controller 331 may control the switch 332 to reproduce the main subtitle data.

As is described above, whether to select main subtitle data or sub subtitle data may be determined by using the switch controller 331. Thus, reproducing main data and sub data without confusing a user is possible.

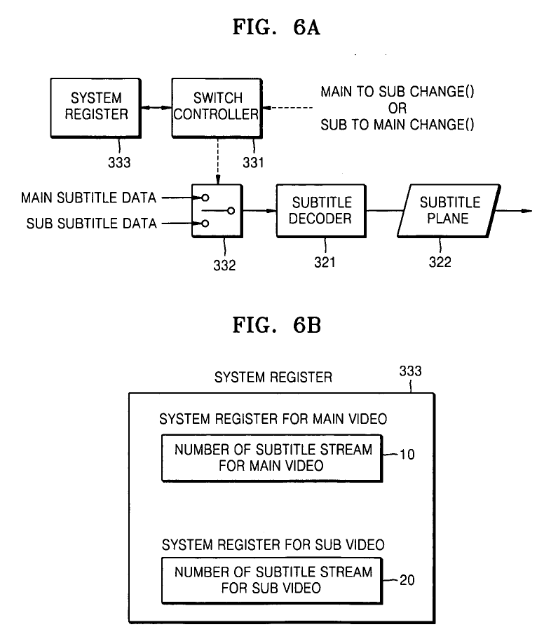

FIG. 6A is a block diagram illustrating a user operation that is input to the switch controller 331. As shown in FIG. 6A, when main video data and sub video data are simultaneously reproduced, two user operations that allow a user to switch between a plurality of pieces of subtitle data, each being related to one of a plurality of pieces of video data, are as follows:
1. Main to Sub Change( ): switch from main subtitle data to sub subtitle data for sub video data during reproduction of the main subtitle data; or
2. Sub to Main Change( ): switch from sub subtitle data to main subtitle data for main video data during reproduction of the sub subtitle data.

When one of the above user operations is input to a user input processor (not shown) from a user input device, the user input processor delivers the received user operation to the switch controller 331, and the switch controller 331 interprets the user operation. The switch controller 331 then controls the switch 332 to switch from the main subtitle data to the sub subtitle data when the user operation is “Main to Sub Change( ),” and controls the switch 332 to switch from the sub subtitle data to the main subtitle data when the user operation is “Sub to Main Change( ).”

FIG. 6B is a detailed block diagram of the system register 333 illustrated in FIG. 6A according to an embodiment of the present invention. Referring to FIG. 6B, the system register 333 includes a system register for main video data and a system register for sub video data. The system register for main video data stores, for example, a subtitle stream number 10 for main video, and the system register for sub video stores, for example, a subtitle stream number 20 for sub video.

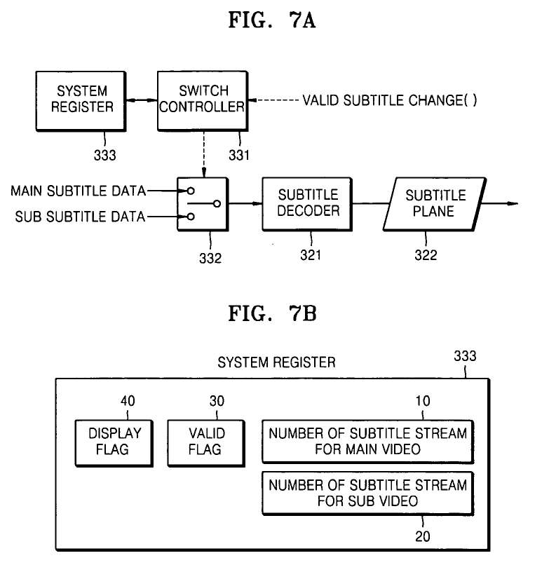

FIG. 7A is a block diagram illustrating a user operation input to the switch controller 331. As shown in FIG. 7A, when main video data and sub video data are simultaneously reproduced by a reproducing apparatus, a user operation that allows a user to switch between a plurality of pieces of subtitle data, each piece of subtitle data being related to one of a plurality of pieces of video data, is as follows:

Valid_Subtitle_Change( )

The above user operation allows switching from main subtitle data to sub title data when the user preference information stored in the system register 333 is set to the main subtitle data to occur, and switching from sub subtitle data to main subtitle data when the user preference information stored in the system register 333 is set to the sub subtitle data to occur. For example, when a valid flag field of the system register 333, illustrated in FIG. 6B, has a value of 0b, 0b is switched to 1b, and when the valid flag field has a value of 1b, 1b is switched to 0b.

FIG. 7B is a detailed block diagram of the system register 333 illustrated in FIG. 7A according to another embodiment of the present invention. As shown in FIG. 7B, the system register 333 includes a display flag 40 that represents whether subtitle data is on/off, a valid flag 30 that represents whether the stream number of subtitle data to which a reproducing apparatus currently refers in order to reproduce subtitle data is for main video or sub video, a register 10 that stores the stream number of a subtitle stream for main video, and a register 20 that stores the stream number of a subtitle stream for sub video.

The valid flag 30 may be defined, as follows:
0b: the stream number of current subtitle data to be reproduced via a subtitle decoder is related to sub subtitle data; and
1b: the stream number of current subtitle data to be reproduced via the subtitle decoder is related to main subtitle data.

When the user operation, Valid_Subtitle_Change( ), illustrated in FIG. 7A, is delivered to the switch controller 331, the switch controller 331 refers to the system register 333. If the valid flag 30 of the system register 333 has a value of 0b, that is, it sets to a stream number of subtitle data for sub video, the switch controller 331 resets the value of the valid flag 30 to 1b, and also controls the switch 332 so that main subtitle data is input as subtitle data to the subtitle decoder. Thus, the demultiplexer 350 transmits subtitle data, i.e., main subtitle data, which corresponds to the stream number of a stream of subtitle data that is to be reproduced, to the subtitle decoder 321, and the subtitle decoder 321 reproduces the received subtitle data.

As is described above, smoothly switching between a plurality of pieces of subtitle data that share a subtitle decoder and a plane for subtitles by using the system register 333 and user operations is possible.

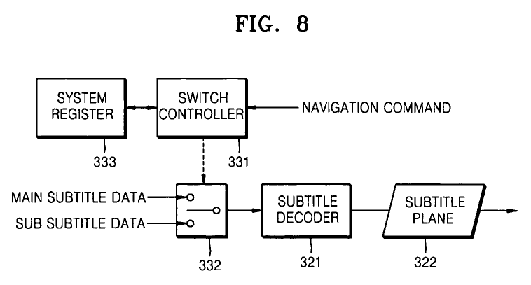

FIG. 8 is a block diagram of a command input to the switch controller 331 illustrated in FIG. 5 according to another embodiment of the present invention. Although a user operation has been described above, as an example of a command input to the switch controller 331 in order to set or select user preference information, with reference to FIGS. 6A and 7A, a navigation command may also be input.

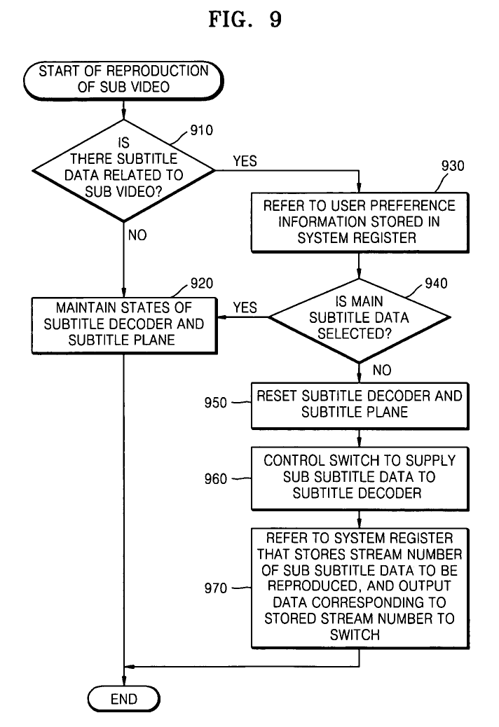

FIG. 9 is a flowchart illustrating a method of processing subtitle data when a reproducing apparatus simultaneously reproduces main video and sub video according to an embodiment of the present invention. As shown in FIG. 9, when reproduction of sub video data begins during reproduction of main video, whether there is subtitle data for the sub video data which is related to the sub video data that is being reproduced is determined (Operation 910).

If it is determined, in operation 910, that subtitle data for the sub video data, that is, sub subtitle data, is not present, current states of a subtitle decoder and a subtitle plane are maintained (Operation 920). That is, the subtitle decoder 350 illustrated in FIG. 5 continues decoding when main subtitle data which is subtitle data for the main video data is being decoded. If it is determined, in operation 910, that subtitle data for sub video is present, the switch controller 331 refers to user preference information according to an embodiment of the present invention, which is stored in the system register 333 (Operation 930).

Even if the sub video data is reproduced, whether the main subtitle data is selected is determined based on the user preference information (Operation 940). When the user preference information indicates that the main subtitle data is selected, and, thus, the main subtitle data is maintained, the current states of the subtitle decoder 321 and the subtitle plane 322 are maintained in operation 920.

If the user preference information indicates that subtitle data for sub video data is reproduced during reproduction of the sub video, the subtitle decoder 321 and the subtitle plane 322 are reset to discontinue reproduction of the main subtitle data (Operation 950). Next, the switch controller 331 controls the switch 332 to supply the sub subtitle data to the subtitle decoder 321 (Operation 960). Lastly, the demultiplexer 350 refers to the system register 333 that stores a stream number of sub subtitle data to be reproduced, and outputs data corresponding to the stored stream number to the switch 332 (Operation 970).

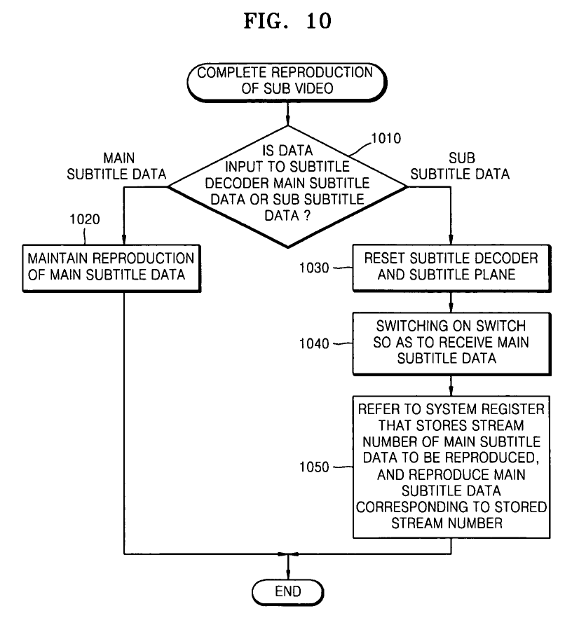

FIG. 10 is a flowchart illustrating an operation of a reproducing apparatus when reproduction of sub video is completed, according to an embodiment of the present invention. As shown in FIG. 10, when main video and sub video are simultaneously reproduced, and the reproduction of the sub video is completed while main subtitle data or sub subtitle data is displayed, whether data that is input to the subtitle decoder 321, illustrated in FIG. 5, is the main subtitle data or the sub subtitle data is determined (Operation 1010).

If the data input to the subtitle decoder 321, that is, the subtitle data that is being currently reproduced, is the main subtitle data, the main subtitle data continues to be reproduced (Operation 1020). That is, current states of the subtitle decoder 321 and the subtitle plane 322 are maintained. If the subtitle data that is currently being reproduced is the sub subtitle data, the subtitle decoder 321 and the subtitle plane 322 are reset (Operation 1030). After the reset, the switch controller 331 switches on the switch 332 in order to receive the main subtitle data (Operation 1040).

Also, after switching on the switch 332 in order to receive the main subtitle data, the demultiplexer 350 refers to the system register 333 that stores a stream number of main subtitle data to be reproduced, and outputs main subtitle data that corresponds to the stored stream number to the subtitle decoder 321. Then, the subtitle decoder 321 reproduces the main subtitle data (Operation 1050).

FIG. 11 is a flowchart illustrating a method of switching between reproduction of one piece of subtitle data and reproduction of another piece of the subtitle data, where each piece of subtitle data is from among a plurality of pieces of subtitle data each being related to one piece of video data, which are linked to a particular piece of the video data, while reproducing a plurality of pieces of the video data according to the user operation illustrated in FIG. 6A, according to an embodiment of the present invention. As shown in FIG. 11, when a user input instructing a switch from subtitle data for main video to subtitle data for sub video is received (Operation 1110), a decoder and a plane, for subtitle data, which are currently being used are reset (Operation 1120), and switching is performed so as to allow for an input of subtitle data that is related to sub video data to the decoder for subtitle data (Operation 1130).

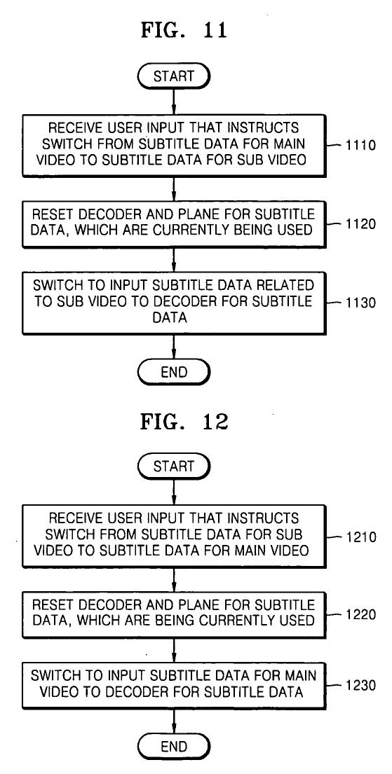

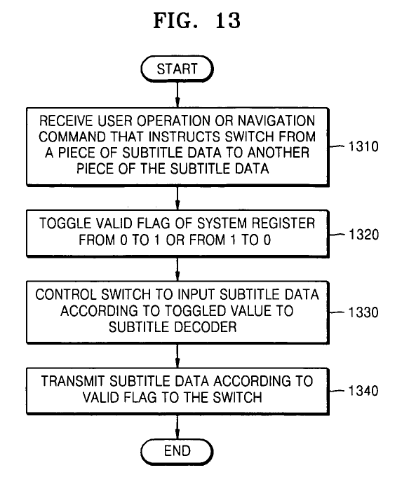

FIG. 12 is a flowchart illustrating a method of switching between reproduction of one piece of subtitle data and another piece of the subtitle data. Here, each piece of subtitle data is from among a plurality of pieces of subtitle data. Each of the pieces of subtitle data is related to one piece of video data, and is linked to a particular piece of the video data. The method occurs during a reproduction of a plurality of pieces of the video data according to the user operation illustrated in FIG. 6A and according to another embodiment of the present invention. As shown in FIG. 12, when a user input instructing a switch from subtitle data for sub video to subtitle data for main video data is received (Operation 1210), a decoder and a plane, for subtitle data, which are being currently used are reset (Operation 1220), and switching is performed so as to allow for an input of the subtitle data for main video data to the decoder for subtitle data (Operation 1230).

FIG. 13 is a flowchart illustrating a method of switching between reproduction of one piece of subtitle data and reproduction of another piece of the subtitle data. Here, each piece of subtitle data is from among a plurality of pieces of subtitle data, each being related to a piece of video data, which are linked to a particular piece of the video data, while reproducing a plurality of pieces of video data according to the command illustrated in FIG. 7A, according to an embodiment of the present invention. As shown in FIG. 13, a switch controller receives a user operation or a navigation command instructing a switch from a piece of subtitle data to another piece of the subtitle data (Operation 1310).

Then, the switch controller toggles a valid flag of a system register from 0 to 1 or from 1 to 0 according to the user operation or the navigation command (Operation 1320). That is, when the valid flag is set to 0, 0 is changed to 1, and vice versa. Next, the switch controller controls a switch so as to input subtitle data according to the toggled value to a subtitle decoder (Operation 1330). Lastly, a demultiplexer transmits the subtitle data according to the toggled valid flag of the system register to the switch so that the subtitle data may be decoded by a subtitle decoder (Operation 1340).

As described in the above-mentioned embodiments, aspects of the present invention have been described with respect to a piece of main video data and a piece of sub video data for convenience of explanation, but are not limited thereto. Aspects of the present invention are applicable to a case where a plurality of pieces of main video data and a plurality of pieces of sub video data are present. Also, as is described above, additional data related to video data according to aspects of the present invention is not limited to subtitle data. That is, the additional data includes menu data, OSD data, or graphic data.

A reproducing method according to aspects of the present invention may be embodied as computer readable code in a computer readable medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable medium may be distributed among computer systems that are interconnected through a network, and the present invention may be stored and implemented as computer readable code in the distributed system. Also, a function program, code, and code segments needed to perform the reproducing apparatus according to the present invention may easily be derived by programmers in the technical field to which the present invention pertains.

As is described above, aspects of the present invention provide a reproducing apparatus and method capable of setting a plurality of pieces of additional data to be simultaneously reproduced according to a preference of a user when reproducing a plurality of pieces of video data, and capable of performing a switch from a piece of additional data to another piece of the additional data, which are linked to a particular piece of video data.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus to reproduce at least one piece of video data, comprising:
a data reproducing unit to reproduce the at least one piece of video data;
an additional data reproducing unit to reproduce one of a plurality of pieces of additional data, each being related to the one of the at least one piece of video data; and
a control unit to control the additional data reproducing unit to select and reproduce the one of the pieces of additional data.

2. The apparatus according to claim 1, wherein the data reproducing unit comprises:
a plurality of video decoders to decode the at least one piece of video data; and
a plurality of video planes to output the decoded video data, wherein the additional data reproducing unit comprises:
an additional data decoder to decode the additional data selected by the control unit; and
an additional data plane to output the decoded additional data.

3. The apparatus according to claim 1, wherein the control unit comprises:
a switch to switch between the pieces of the additional data so as to allow for an input of the one of the pieces of additional data to the additional data reproducing unit; and
a switch controller to control the switch to select the one of the pieces of additional data according to a received command.

4. The apparatus according to claim 3, wherein the received command comprises either a user operation or a navigation command.

5. The apparatus according to claim 3, wherein the control unit further comprises a system register to store user preference information regarding the one of the pieces of additional data to be reproduced.

6. The apparatus according to claim 5, wherein the user preference information stored in the system register is set according to a user operation or a navigation command.

7. The apparatus according to claim 4, wherein the switch controller resets the additional data decoder and the additional data plane according to the user operation or the navigation command.

8. The apparatus according to claim 1, wherein the additional data comprises at least one of subtitle data, on screen display data, menu data, and graphic data.

9. The apparatus according to claim 4, wherein the pieces of additional data comprise:
subtitle data for the main video data; and
subtitle data for sub video data.

10. The apparatus according to claim 9, wherein the received command comprises one of:
a command which instructs that switching be performed from the subtitle data for the main video data to the subtitle data for the sub video data; and
a command which instructs that switching be performed from the subtitle data for the sub video data to the subtitle data for the main video data.

11. The apparatus according to claim 8, wherein the system register comprises:
a register to store a stream number of a subtitle stream for the main video data; and
a resister to store a stream number of a subtitle stream for the sub video data.

12. The apparatus according to claim 4, wherein each of the pieces of the additional data comprises:
subtitle data for the main video data; and
subtitle data for sub video data.

13. The apparatus according to claim 12, wherein the received command comprises a command that instructs currently set user preference information to be toggled.

14. The apparatus according to claim 10, wherein the system register comprises a valid flag to identify whether the user preference information represents the subtitle data for the main video data or the subtitle data for the sub video data.

15. A method of reproducing a plurality of pieces of video data, comprising:
decoding the pieces of the video data;
selecting one of a plurality of pieces of additional data, each being related to one of the pieces of video data;
decoding the selected piece of additional data; and
outputting the decoded pieces of the video data together with the decoded piece of additional data.

16. The method according to claim 15, wherein the selecting of the one of the pieces of additional data comprises selecting the one of the pieces of additional data according to a user operation or a navigation command which instructs that switching is to be performed between the pieces of additional data.

17. The method according to claim 15, wherein the selecting of the one of the pieces of additional data comprises:
referring to a system register which stores user preference information regarding a piece of additional data, which is to be reproduced; and
selecting the one of the pieces of the additional data according to the user preference information stored in the system register.

18. The method according to claim 17, wherein the user preference information stored in the system register is set according to a user operation or a navigation command.

19. The method according to claim 17, wherein the pieces of additional data comprise:
subtitle data for the main video data; and
subtitle data for sub video data.

20. The method according to claim 19, wherein the system register comprises a valid flag to identify whether the user preference information represents the subtitle data for the main video data or the subtitle data for the sub video data.

21. The method according to claim 15, wherein the additional data comprises at least one of subtitle data on screen display data menu data, and graphic data.

22. The method of claim 15, wherein the selecting of the one of the pieces of the additional data comprises:
switching so that a second piece of the additional data is decoded, when a user input, which instructs that switching be performed from a first piece of additional data to a second piece of additional data, is received; and
switching so that the first piece of the additional data is decoded, when a user input, which instructs a switch from the second additional data to the first additional data, is received.

23. The method according to claim 15, wherein, when reproduction of a piece of the video data related to the selected piece of the additional data is completed, the method further comprises:
completing the decoding of the selected piece of the additional data;
decoding a piece of the additional data related to another piece of the video data; and
outputting a result of the decoding.

24. A method of controlling a reproduction of a plurality of pieces of video data, the method comprising:
determining whether sub additional data for sub video data is present when a plurality of pieces of video data, including main video data and the sub video data, is reproduced;
when the sub additional data is determined to not be present, maintaining current states of an additional data decoder and an additional data plane which are currently in use;
when the sub additional data is determined to be present, referring to a system register which stores user preference information indicating whether to select main additional data or the sub additional data; and
controlling the additional data decoder and the additional data plane according to the user preference information.

25. The method according to claim 24, wherein the controlling of the additional data decoder and the additional data plane comprises:
maintaining the current states of the current additional data decoder and the additional data plane, when the user preference information indicates that the main additional data is to be selected; and
resetting the current additional data decoder and the current additional data plane; and
controlling the sub additional data to be input to the additional data decoder, when the user preference information indicates that the sub additional data is to be selected.

26. A method of controlling a reproduction of a plurality of pieces of video data, the method comprising:
when a user input is received, which instructs that a switch from additional data for main video data to additional data for sub video data is to be made, resetting an additional data decoder and an additional data plane which are currently being used;
switching so as to input the additional data for the sub video data to the additional data decoder;
when a user input is received, that instructs that a switch from the additional data for the sub video data to the additional data for the main video data is to be made, resetting the current additional data decoder and the current additional data plane; and
switching so as to input the additional data for the main video data to the additional data decoder.

27. A method of controlling a reproduction of a plurality of pieces of video data, the method comprising:
determining whether additional data that is currently being reproduced is main additional data for main video data or sub additional data for sub video data, when reproduction of sub video data is completed during a reproduction of a piece of additional data, which is related to one of the pieces of the video data and is linked to a particular piece of the video data, while reproducing the pieces of the video data including the main video data and the sub video data;
when the additional data that is being currently reproduced is determined to be main additional data, maintaining current states of an additional data decoder and an additional data plane that are currently used; and
when the additional data that is being currently reproduced is determined to be sub additional data, resetting the current additional data decoder and the additional data plane, and switching so as to input the main additional data to the additional data decoder.

28. The method according to claim 27, further comprising referring to a system register which stores a stream number of a stream of the main additional data that is to be reproduced, and decoding and reproducing a piece of the additional data corresponding to the stored stream number.

29. A recording/reproducing apparatus to record/reproduce video data, comprising:
a data reproducing unit to reproduce the video data;
an additional data reproducing unit to reproduce an item of additional data, the item of additional data being related to a first part of the video data; and
a control unit to control the additional data reproducing unit to select the item of additional data from a set of items of additional data, each of the items of the additional data being related to parts of the video data beside the first part.

30. The apparatus according to claim 29, wherein the data reproducing unit comprises:
a plurality of video decoders to decode the video data; and
a plurality of video planes to output the decoded video data.

31. The apparatus according to claim 30, wherein the additional data reproducing unit comprises:
an additional data decoder to decode the selected item of additional data; and
an additional data plane to output the decoded additional data.

32. The apparatus according to claim 29, wherein the control unit comprises:
a switch to allow for an input of the item of additional data to the additional data reproducing unit; and
a switch controller to control the switch according to a received command.

33. The apparatus according to claim 29, wherein the item of additional data comprises at least one of subtitle data, on screen display data, menu data, and graphic data.

34. A recording/reproducing apparatus to record/reproduce data, comprising:
a data reproducing unit to reproduce video data and sub-data;
an additional data reproducing unit to reproduce an item of additional data, the item of additional data being related to either the video data or the sub-data; and
a control unit to control the additional data reproducing unit to select the item of additional data from a set of items of additional data, each of the items of the additional data being related to either the video data or the sub-data based on a user command or a navigation command.
